(19) United States
(12) Patent Application Publication
(10) Pub. No.: US 2011/0155313 A1
(43) Pub. Date: Jun. 30, 2011

(54) DOCUMENT SECURITY

(76) Inventor: Stephen Paul Black, West Midlands (GB)

(21) Appl. No.: 12/516,282

(22) PCT Filed: Nov. 23, 2007
(86) PCT No.: PCT/GB2007/004495

§ 371 Date: Jan. 27, 2011

(30) Foreign Application Priority Data
Nov. 23, 2006 (GB) 0623341.5
May 31, 2007 (GB) 0710385.6

(51) Int. Cl. B32B 38/10; B42D 15/00

(52) U.S. Cl. 156/249; 283/81

(57) ABSTRACT

A form or label for securely carrying confidential information has a lamina including a printable face layer having a plurality of printable areas and a backing layer secured to the face layer and having a plurality of areas aligned with the printable areas of the face layer. The printable areas of the face layer are separable therefrom and the aligned areas of the backing layer include at least one transfer area separable therefrom. A substrate has a carrier layer releasably secured to the backing layer such that, when separating the carrier layer and the backing layer, the at least one transfer area remains secured to the carrier layer together with the aligned printable area of the face layer thereby transferring information from the face layer to the carrier layer.

This invention relates to document security and in particular to tamper-evident forms or labels for securely carrying confidential information.

The invention has particular, but not exclusive, application to personal identification numbers (PIN) supplied to customers by financial institutions such as banks to enable the customer to validate a credit card or the like at the point of use. Secure transmission of a PIN to a customer is vital to reduce or prevent the fraudulent mis-use of credit cards.

Traditionally, the PIN is mailed to the customer using a tamper-evident form which enables the customer to detect if security has been breached by any unauthorised access to the PIN prior to receipt by the customer. A tamper evident form for securely transmitting a PIN is disclosed in UK Patent No. 2 331 270 in which the form has an upper transparent lamina on which the PIN is printed and a lower non-transparent lamina carrying a mass of alpha-numeric characters which act as scrambling means to prevent the PIN being read when the upper and lower laminas are joined together wherein the lamina are separable to reveal the PIN printed on the upper transparent lamina. This form relies on the presence of scrambling means so that the PIN is effectively hidden from view until the scrambling means is separated from the part of the form carrying the PIN.

The present invention seeks to provide an improved form or label for securely carrying confidential information. It is a preferred aim of the invention to provide a form or label that is tamper-evident and which does not rely on scrambling means to hide the confidential information from view.

According to a first aspect of the present invention there is provided a form or label for securely carrying confidential information, wherein information is printed on a lamina overlying a substrate, wherein a portion of the lamina is secured to the substrate and a remaining portion of the lamina or a portion of the substrate to which the portion of the lamina is secured is removable from the form or label such that part of the information printed on the lamina is transferred to the substrate.

Preferably, the lamina is printed with the confidential information and with fake or dummy information such that the actual position of the confidential information is concealed until the removable portion of the lamina or substrate is separated from the form or label. The part of the information transferred to the substrate may be the confidential information and the part of the information remaining with the lamina may be the dummy information. Alternatively, the part of the information transferred to the substrate may be the dummy information and the part of the information remaining with the lamina may be the confidential information.

Preferably, the lamina has a plurality of printable areas wherein at least one printable area is secured to the substrate so as to separate from the lamina when the removable part of the lamina or substrate is detached from the form or label and thereby carry with it information printed on the printable area.

Preferably, said at least one printable area of the lamina is secured to the substrate through an. aligned transfer portion of an intermediate layer of the form that is positioned between the lamina and the substrate.

In one arrangement, the aligned transfer portion of the intermediate layer is a cut-out and the at least one printable area of the lamina is secured to the substrate by adhesive. Preferably, the cut-outs are filled with adhesive. In this way, the form is of uniform thickness and the position of the cut-outs cannot be detected by local variations in the thickness of the form where the cut-outs are provided.

In another arrangement, the aligned transfer portion of the intermediate layer is a detachable portion that is secured on one side to the at least one printable area of the lamina and on the other side to the substrate by adhesive and is separable from the remaining portion of the intermediate layer when the removable part of the lamina or substrate is detached from the form or label. In this way, the form or label is of uniform thickness and the position of the detachable areas of the lamina and intermediate layer cannot be detected.

Preferably, the number of aligned transfer portions of the intermediate layer is less than the number of printable areas whereby information printed on the or each printable area of the lamina registered with an aligned transfer portion of the intermediate layer out transfers to the substrate and information printed on the or each printable area of the lamina not registered with an aligned transfer portion remains with the lamina when the removable part of the lamina or substrate is detached from the form or label.

Preferably, the printable areas are arranged in rows and columns to form a grid and the position of the aligned transfer portions in the underlying intermediate layer of the form or label can be pre-set and used to control a printer printing the confidential information on the printable areas within the grid. For example the form or label may be used with a computer controlled laser printer to print confidential information on printable areas registered with transfer portions and dummy information on printable areas not registered with transfer portions or vice versa. The position of the or each transfer portion can be changed so that the actual position of the confidential information within the grid can be altered.

Preferably, the position of the transfer portions in the intermediate layer of the substrate is concealed and cannot be determined until the removable part of the lamina or substrate is separated from the form or label. For example, the lamina and substrate may comprise opaque sheets, layers or films of paper or other suitable material such as polyester.

In one arrangement, the printable areas of the lamina are defined by “kiss-cuts” in which the depth of cut is less than the thickness of the lamina, i.e. a partial or incomplete cut

In another arrangement, the printable areas of the lamina are defined by “complete cuts” in which the depth of cut extends through the entire thickness of the lamina, i.e. a full or total cut.

The kiss-cuts and complete cuts may be formed by die-cutting with appropriate control of the depth of cut.

In both arrangements, some of the printable areas of the lamina are secured to the substrate through aligned transfer portions of the intermediate layer so as to be transferred to the substrate when the removable part of the lamina or substrate is separated from the form. The intermediate layer may be part of the substrate. Alternatively, the intermediate layer may be part of the lamina.

According to a second aspect of the invention, there is provided a form or label for securely carrying confidential information, the form or label comprising a printable face layer having a plurality of printable areas, a backing layer secured to the face layer and having a plurality of areas aligned with the printable areas of the face layer, the printable areas of the face layer being separable therefrom and the aligned areas of the backing layer including at least one transfer area separable therefrom, and a carrier layer releasably secured to the backing layer such that, when separating the carrier layer and the backing layer, the at least one transfer area remains secured to the carrier layer together with the aligned printable area of the face layer.

In this way, information printed on the printable area of the face layer aligned with a transfer area of the backing layer is transferred from the face layer to the carrier layer.

According to a third aspect of the invention, there is provided a method of producing a form for securely carrying confidential information including the steps of providing a lamina with a plurality of printable areas and selectively bonding at least one of the printable areas to a substrate whereby information printed on said at least one printable area of the lamina is transferred to the substrate leaving behind information printed on the remaining printable areas when the substrate or lamina is separated from the form.

The information transferred to the substrate may be confidential information with the information left behind on the lamina being dummy (fake or false) information. Alternatively, the information transferred to the substrate may be dummy information with the information left behind on the lamina being confidential information.

According to a fourth aspect of the present invention there is provided a form or label for securely carrying confidential information, the form or label comprising a lamina secured to a substrate, wherein parts of the lamina and substrate are separable such that a portion of the lamina together with information printed thereon is transferred to the substrate.

According to a fifth aspect of the invention, there is provided a method of producing a form or label for securely carrying confidential information including the steps of providing a lamina with a plurality of printable areas, selectively bonding at least one of the printable areas to a part of a substrate to which the lamina is attached, printing information on said printable areas, and separating the lamina and said part of the substrate whereby information printed on said at least one of the printable areas of the lamina is transferred to the part of the substrate leaving behind the remaining part of the information on the lamina.

According to a sixth aspect of the invention, there is provided a form or label for securely carrying confidential information, the form or label comprising a lamina overlying a substrate, wherein a portion of the lamina is secured to the substrate and a remaining portion of the lamina or a portion of the substrate to which the portion of the lamina is secured are separable such that part of the information printed on the lamina is transferred to the substrate.

The invention will now be described in more detail by way of example only with reference to the accompanying drawings wherein:

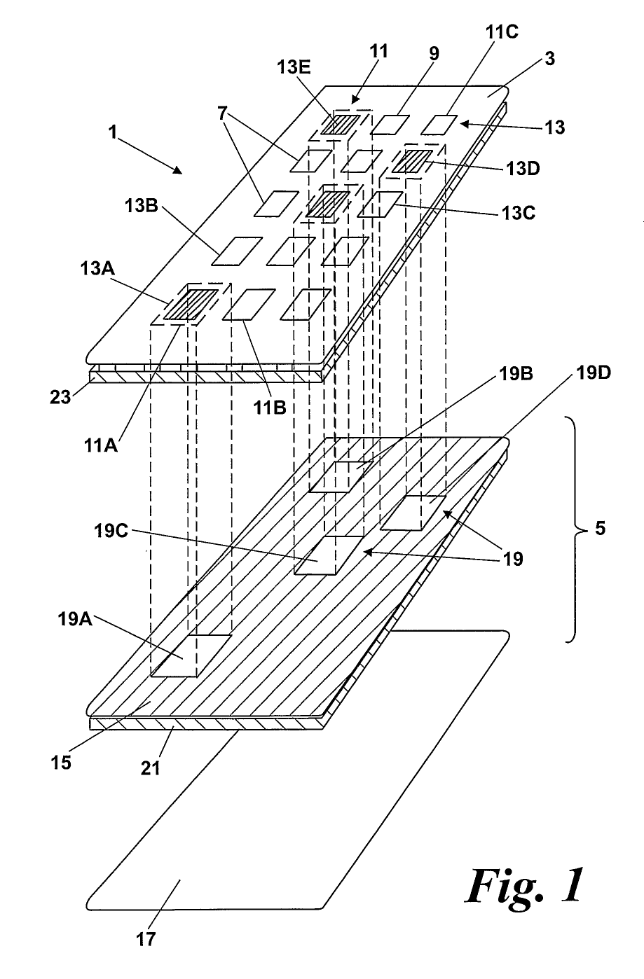

FIG. 1 is an exploded perspective view of a form according to a first embodiment of the invention showing information printed on a lamina of the form;

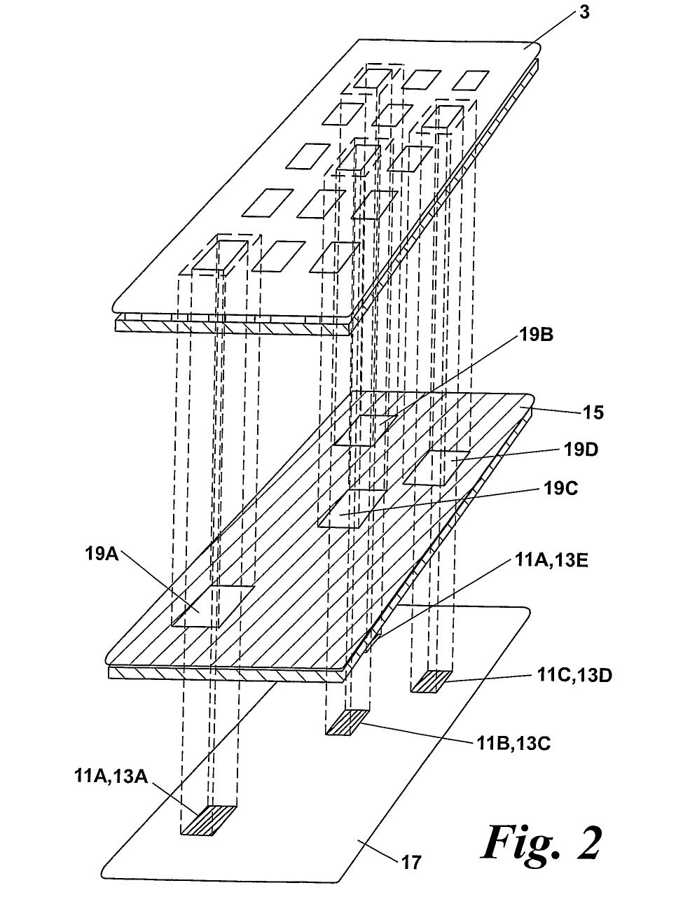

FIG. 2 is an exploded perspective of the form shown in FIG. 1 showing the information transferred to a removable part of a substrate of the form;

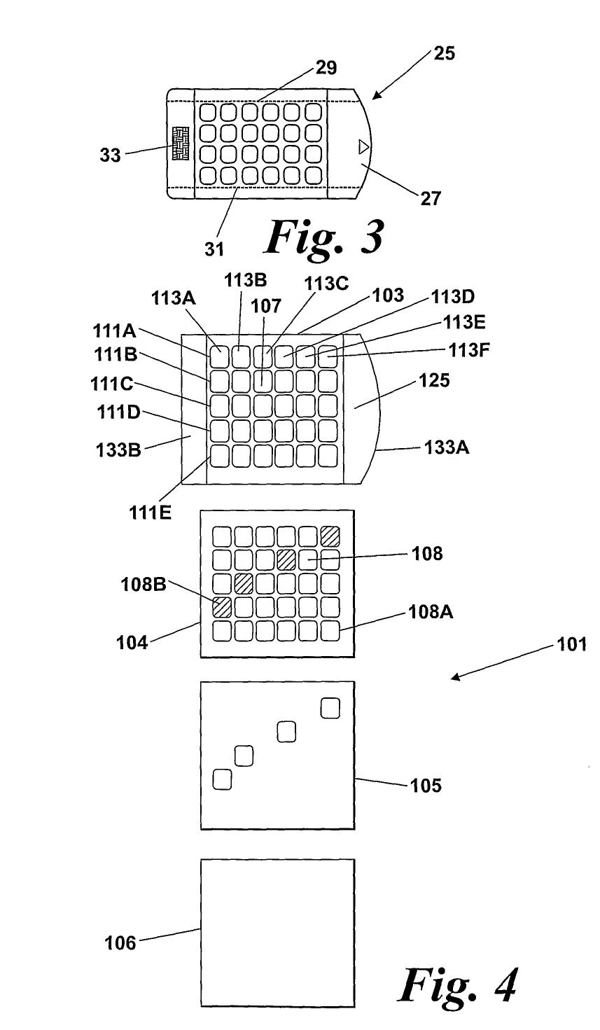

FIG. 3 shows a modification to the form shown in FIGS. 1 and 2; and

FIG. 4 shows an exploded view of a form according to a second embodiment of the invention.

Referring to FIGS. 1 and 2 of the drawings, there is shown a first embodiment of a tamper-evident form 1 for securely carrying confidential information such as a PIN number for a bankcard, credit card or the like.

The form 1 has a lamina 3 secured to a substrate 5 by a suitable adhesive. The lamina 3 is a sheet of paper or the like on which information can be printed. As shown the lamina 3 has an array of printable areas 7 defined by incomplete or partial die cuts 9 commonly referred to in the art as “kiss-cuts”.

In this embodiment, the printable areas 7 are of rectangular shape arranged in a grid comprising rows 11 and columns 13 with the printable areas aligned in each row and in each column so that the position of the printable areas is known with a high degree of accuracy. It will be understood that the printable areas may be of other shape, for example oval, triangular or circular.

In this embodiment there are three rows 11A, 11B, 11C and five columns 13A, 13B, 13C, 13D, 13E giving a total of fifteen printable areas 7 each having a unique location in the grid defined by their position in a particular row and column. It will be understood that the grid may comprise any number of printable areas 7.

The substrate 5 includes two lamina 15,17 releasably secured together by any suitable adhesive 21. The lamina 15 is a thin film or sheet of paper forming an intermediate layer located between the lamina 3 and the lamina 17 and has a plurality of cut-out areas 19 forming transfer portions in the intermediate layer of corresponding shape to the printable areas 7 of the lamina 3. The lamina 17 is a sheet of paper or the like.

The lamina 3 is secured to the lamina 15 of the substrate 5 by adhesive 23 that also secures the lamina 3 to the lamina 17 of the substrate 5 in the region of the cut-out areas 19 in the lamina 15. The cut-out areas 19 are arranged to align with printable areas 7 of the lamina when the lamina 3 and lamina 15 are secured together. The adhesive 23 fills the cut-out areas 19 so that the position of the cut-outs cannot be detected by local variations in the thickness of the form due to the presence of the cut-outs in the lamina 15.

In use, when the lamina 17 is separated from the lamina 15, the printable areas 7 of the lamina 3 secured to the lamina 17 through the cut-out areas 19 in the lamina 15 separate from the lamina 3 and remain adhered to the lamina 17 thereby effectively transferring any information printed on these areas to the lamina 17 (see FIG. 2).

In a modification (not shown), the cut-out areas 19 in the lamina 15 are replaced by areas defined by incomplete or partial die cuts similar to the die cuts 9 referred to above as “kiss-cuts” that are bonded on one side to the lamina 17 and on the other side to the lamina 3. In this way, the printable areas 7 of the lamina 3 are secured to the lamina 17 through kiss-cut areas of the lamina 15 that define transfer portions and, when the lamina 17 is separated from the lamina 15, the printable areas 7 of the lamina 3 and the kiss-cut areas of the lamina 15 to which they are adhered separate from the form and remain adhered to the lamina 17 thereby effectively transferring any information printed on these areas to the lamina 17. By eliminating the cut-out areas 19, the risk of the position of the transfer portions and the printable areas 7 being detected by local variations in the thickness of the form may be avoided.

In this embodiment, there are four cut-out areas 19A, 19B, 19C, 19D positioned to register with corresponding printable areas 11A13A, 11A13E, 11B13C, 11C13D of the lamina 3 that adhere to the lamina 17 through the cut-out areas. The remaining printable areas of the lamina 3 are covered by and adhere to the lamina 15. In this way, the lamina 15 acts to mask some of the printable areas of the lamina 3 from the lamina 17.

In use, the confidential information such as the digits of a PIN number are printed on the printable areas of the lamina 3 that are aligned with cut-out areas 19 of the lamina 15. The remaining printable areas of the lamina 3 are printed with dummy information comprising random digits so that, in the printed form, all the printable areas 7 of the lamina 3 carry a digit.

Both the lamina 3 and the lamina 17 are opaque so that the position of the cut-out areas 19 is concealed in the printed form and the position of the digits corresponding to the confidential information relative to the position of the digits corresponding to the dummy information cannot be determined until the lamina 17 is separated from the form and brings with it the printable areas corresponding to the cut-out areas 19 on which the confidential information has been printed and leaving behind the dummy information on the form. Alternatively, in a modification, the dummy information may be printed on printable areas corresponding to the cut-out areas 19 with the confidential information being printed on the remaining printable areas so that, when the lamina 17 is separated from the form, it brings with it the dummy information and leaving behind the confidential information on the form. In this way, the confidential information is only revealed when the lamina 17 is separated from the form 1. For example, the lamina 17 may be in the form of a so-called “bullet” that is removable from the form when it is desired to reveal the confidential information.

In the above-described form, the confidential information is revealed when lamina 17 forming part of the substrate is removed from the form. It will be understood, however, that the form could be configured so that the confidential information is revealed when the lamina 3 on which the information is printed is removable from the form. Thus, lamina 3 may be releasably bonded to lamina 15 with the printable areas aligned with the cut-outs 19 bonded to the lamina 17 through the cut-outs 19 so as to separate from the lamina 3 and transfer the information to the lamina 17 when the lamina 3 is separated from the form. For example, the lamina 3 may be in the form of a so-called “bullet” that is removable from the form when it is desired to reveal the confidential information. The information transferred to the substrate may be the confidential information that is left behind on the form when the lamina 3 is removed carrying with it the dummy information. Alternatively, the information transferred to the substrate may be the dummy information that is left behind when the lamina 3 is removed carrying with it the confidential information.

It will be appreciated that the number and/or position of the cut-out areas 19 in the lamina 15 of the substrate 5 may be changed according to the type of confidential information to be printed on the form 1. In general, the number of cut-out areas 19 will be less than the number of printable areas 7 so that the lamina 3 is printed with both confidential information and dummy information. In this way, all the digits are visible on the printed form 1 including the digits forming the confidential information and the confidential information is effectively concealed as it is impossible to known which digits form the confidential information.

We envisage that the form 1 will be printed using a printer such as a laser printer controlled by a processor such as a computer, laptop, notebook, palm top or the like electronic device to print the confidential information in the printable areas 7 that are aligned with the cut-outs 19 and to print the dummy information in the remaining printable areas 7.

The position of the cut-outs 19 can be set-up by the supplier of the form 1 and a plurality of forms 1 can be provided with a programme (software) or the like for the end user to control operation of the printer to ensure the confidential information is printed in the correct position on each form 1.

The position of the cut-outs 19 and thus the printed confidential information can be changed by using lamina 15 with different arrangements of the cut-outs 19 to produce the form 1. In this way, the supplier of the form 1 knows the position of the cut-outs and provides this information to the end user in a machine readable form which is used to programme the printer. The end user therefore only has to synchronise operation of the printer to match the pre-determined position of the cut-outs in the forms 1 to a customer list to print the form with the correct PIN number in the correct position.

In an alternative arrangement, each form can be provided with an identity mark or code that can be used to identify the position of the cut-outs as the form is fed to the printer and provide a signal to the software controlling operation of the printer to print the PIN in the correct position on the form. In this way, the position of the cut-outs can be altered from one form to the next and the printer will automatically print the PIN at the correct position. As the operation of the printer is controlled by reading the mark or code applied to each form, the printer does not have to be synchronised to match pre-determined positions of the cut-outs in the forms. As a result, the forms can be presented to the printer in any order.

In one arrangement, the mark or code is provided in a machine readable form such as a data-matrix barcode containing information on the position of the cut-outs that is readable with a magic eye or other suitable device prior to printing the form. The barcode or other mark or code may be provided on a detachable part of the form such that the mark or code can be removed from the form after printing to prevent fraudulent detection of the position of the confidential information after the form has been printed. Alternatively, the barcode or other mark or code may be partially or fully overprinted to alter or destroy the code to prevent fraudulent detection of the position of the confidential information after the form has been printed.

In another arrangement, the mark or code is provided in an electronic form such as a radio frequency identification (RFID) tag containing information on the position of the cut outs that is activated by any suitable means prior to printing the form. The RFID tag may be de-activated after printing to prevent fraudulent detection of the position of the confidential information after the form has been printed. Other suitable electronic forms include an electrically programmable read only memory (EPROM) chip or an electrically erasable programmable read only memory (EEPROM) chip where the stored information can be erased after reading.

The mark or code may identify the actual location of the cut-outs in the form. Alternatively, the mark or code may be used with a look-up table to identify the actual position of the cut-outs in the form. The look-up table can be changed so that different batches of forms may use the same mark or code to identify different positions of the cut-outs. In this way, the position of the cut-outs in any particular batch is not revealed by reading the mark or code applied to the form alone without the corresponding look-up table to refer to. The mark or code may be applied to the form by any suitable means and may be visible but more preferably is invisible for added security.

Referring now to FIG. 3 of the drawings, there is shown a modification to the form above-described in which the removable part of the form—lamina 3 or lamina 17—is in the form of a bullet 25 provided at one end with a pull-tab 27 for removing the bullet 25 from the form by tearing perforations 29,31 provided along both sides of the bullet 25. In this modification, tamper evident means 33 is provided between the lamina 3 or lamina 17 and the adjacent lamina 15 at the end of the bullet 25 remote from the pull-tab 27 that is activated to provide a visual indication if the bullet 25 is removed fully or partially and replaced. Alternatively or additionally, tamper evident means may be provided at the end of the bullet 25 having the pull-tab 27. As a result, inspection of the form 1 will enable a customer to determine if the lamina 17 has been fully or partially separated from the form such that the secure transmission of the confidential information has been compromised. In this way, the form 1 is readily tamper-evident. The form shown in FIG. 3 may include any of the features described above in connection with FIGS. 1 and 2 to identify the location of the printable areas to be printed with the confidential information.

Referring now to FIG. 4 of the drawings, there is shown a second embodiment of a tamper evident form 101 for securely carrying confidential information such as a PIN number for a bankcard, credit card or the like.

The form 101 has a printable face layer or lamina comprising an opaque, for example white, polyester printable film 103 secured to a polyester backing film 104 by a permanent adhesive. The lamina overlies a substrate comprising a transparent polyester carrier film 105 secured to an opaque, for example black, polyester base film 106 by a permanent adhesive. It will be understood that the invention is not limited to polyester films and that any other suitable materials may be used for one or more of the films.

The backing film 104 is releasably secured to the carrier film 105 by a “peelable” adhesive that allows the lamina to be separated from the substrate. As in FIG. 3, the lamina is provided in the form of a bullet 125 provided with tamper evident security means in the form of coloured pull tape 133a,133b at both ends of the printable film 103 that provides a visual indication if a fraudulent attempt is made to remove and replace the lamina to discover the confidential information.

In this embodiment, the printable film 103 is provided with an array of printable areas 107 defined by complete die cuts of rectangular shape arranged in a grid comprising rows 111 and columns 113 with the printable areas aligned in each row and in each column so that the position of the printable areas is know with a high degree of accuracy. It will be understood that the printable areas may be of other shape, for example oval, triangular or circular.

In this embodiment there are five rows 111A, 111B, 111C, 111D, 111E and six columns 113A, 113B, 113C, 113D, 113E, 113F giving a total of thirty printable areas each having a unique location in the grid defined by their position in a particular row and column. It will be understood that the grid may comprise any number of printable areas 107. In use, one or more of the printable areas 107 will carry confidential information and the remaining printable areas 107 will carry fake or dummy information. The position of the printable areas 107 carrying confidential information can be altered within the grid such that the confidential information cannot be determined until the form is opened as described later.

The backing film 104 is provided with an array of areas 108 aligned with the printable areas 107 of the printable film 103. These areas 108 comprise a combination of partial die cuts or kiss-cuts 108A shown plain and complete die-cuts 108B shown hatched. The number and position of the complete die-cuts 108B corresponds to a pre-determined number and position of printable areas 107 of the printable film 103 to be printed with the confidential information. The form is of uniform thickness throughout which prevents the position of the complete die-cuts being determined by measuring the thickness of different regions of the form and is opaque when viewed from above or below which prevents the position of the complete die-cuts being determined by visual inspection of the form.

In this embodiment, the confidential information comprises a four digit PIN number and the backing film 104 has four die-cut areas 108B and twenty six kiss-cut areas 108A. By way of example, the die-cut areas 108B are shown corresponding to the printable areas 111D113A, 111C113B, 111B113D, 111A113F of the printable film 103. The position of these die-cut areas 108B may be identified by any suitable identity mark or code as described previously to enable the positions to be determined for controlling a printer to print the confidential information in the printable areas and fake or dummy information in the other areas.

In use, when the printable film 103 and backing film 104 are separated from the substrate 105, the die-cut areas 108B of the backing film 104 separate from the backing film 103 and remain adhered to the carrier film 105 of the substrate bringing with them the aligned printable areas of the printable film 103 carrying the confidential information. In this way, the confidential information is transferred from the printable film 103 to the carrier film 105 when the printable film 103 and backing film 104 are separated from the substrate taking with them the fake or dummy information and leaving the confidential information behind on the form. In this embodiment, the complete die-cut areas of the backing film 104 provide transfer portions for transferring information from the printable film to the substrate when the form is opened. In a modification, the fake or dummy information may be left behind on the form with the confidential information remaining with the printable film 103 and backing film 104.

It will be understood that while the invention has been described with reference to the secure transmission of a four digit PIN number, the invention is not limited to such use and can be applied to the transmission of any confidential information comprising one or more indicia, whether in the form of numbers, letters, text, graphics, symbols or a combination thereof.

Furthermore, the printable area(s) can be of any size, shape and spacing so that the position of confidential information printed on the form cannot be determined until the part of the substrate adhered to the printable area(s) is separated from the form.

Moreover, it will be appreciated that each printable area may contain one indicia such as an individual digit of a PIN number or a plurality of indicia.

Additionally, while we have described a form in which the array of printable areas is arranged uniformly to form a grid with printable areas aligned in rows and columns, the invention may have application where the printable areas are arranged randomly and the position of one or more printable areas corresponding to cut-outs in the substrate for transferring the printable information is known.

Furthermore, while the printable areas may be spaced apart from each other as described, the invention may equally be effective where the printable areas have one or more edges common with another printable area.

The form may comprise a mailer that can be printed with the name and address of the customer at the same time the confidential information is printed and then folded and sealed for mailing to the customer.

Alternatively, the form may comprise an insert to be placed in an envelope for mailing to the customer. In this case, the envelope may be a window envelope with the name and address of the customer again being printed on the form at the same time the confidential information is printed.

While the invention has been described with particular reference to a form, it may also be applied to a label that is printed and then attached to a letter, mailer or other suitable document to be mailed to the intended recipient of the confidential information. The label may be provided on a release liner that enables the label to be printed and then peeled from the liner for attaching to the document. For example, the substrate may be releasably attached to the liner by a peelable adhesive such that the label can be detached from the liner and secured to the document for despatch to the intended recipient.

Any feature of the embodiments described herein may be combined with any feature of the other embodiments and the invention is deemed to include all combinations of features described herein.

Other applications and uses of the invention to transmit confidential information in a secure manner will be apparent to those skilled in the art.

1. A form or label for securely carrying confidential information, wherein information is printed on a lamina overlying a substrate, wherein a portion of the lamina is secured to the substrate and a remaining portion of the lamina or a portion of the substrate to which the portion of the lamina is secured is removable from the form or label such that part of the information printed on the lamina is transferred to the substrate.

2. A form or label according to claim 1 wherein, the lamina is printed with the confidential information and with fake or dummy information such that the actual position of the confidential information is concealed until the removable portion of the lamina or substrate is separated from the form or label.

3. A form or label according to claim 2 wherein the part of the information transferred to the substrate is one of confidential information and dummy information and the part of the information remaining with the lamina is the other of confidential information and dummy information.

4. (canceled)

5. A form or label according to claim 1 wherein, the lamina has a plurality of printable areas wherein at least one printable area is secured to the substrate so as to separate from the lamina when the removable part of the lamina or substrate is detached from the form or label and thereby carry with it information printed on the printable area.

6. A form or label according to claim 5 wherein, said at least one printable area of the lamina is secured to the substrate through an aligned transfer portion of an intermediate layer of the form that is positioned between the lamina and the substrate.

7. A form or label according to claim 6 wherein, the aligned transfer portion of the intermediate layer is a cut-out and the at least one printable area of the lamina is secured to the substrate by adhesive.

8. (canceled)

9. A form or label according to claim 6 wherein, the aligned transfer portion of the intermediate layer is a detachable portion that is secured on one side to the at least one printable area of the lamina and on the other side to the substrate by adhesive and is separable from the remaining portion of the intermediate layer when the removable part of the lamina or substrate is detached from the form or label.

10. A form or label according to claim 6 wherein, the number of aligned transfer portions of the intermediate layer is less than the number of printable areas whereby information printed on the or each printable area of the lamina registered with an aligned transfer portion of the intermediate layer transfers to the substrate and information printed on the or each printable area of the lamina not registered with an aligned transfer portion remains with the lamina when the removable part of the lamina or substrate is detached from the form or label.

11. (canceled)

12. (canceled)

13. A form or label according to claim 6 wherein, an identity mark or -code is provided to identify the position of the transfer portions, the identity mark or code being provided in a machine readable form or an electronic form.

14. (canceled)

15. A form or label according to claim 13 wherein, the identity mark or code is provided on a detachable part of the form or label.

16. (canceled)

17. A form or label according to claim 13 wherein, the identity mark or code is selected from one of an RFID tag, an EPROM, and an EEPROM.

18. (canceled)

19. (canceled)

20. A form or label according to claim 13 wherein, the identity mark or code identifies the actual position of the transfer portions or can be used with a look-up table to identify the actual position of the transfer portions.

21. (canceled)

22. A form or label according to claim 13 wherein the identity mark or code can be used to control a printer printing the confidential information on the printable areas within the grid.

23. (canceled)

24. (canceled)

25. A form or label according to claim 1 wherein, the lamina and substrate comprise opaque sheets, layers or films.

26. (canceled)

27. (canceled)

28. A form or label according to claim 1 wherein the printable areas of the lamina are defined by partial or complete die cuts.

29. A form according to claim 5 wherein, some of the printable areas of the lamina are secured to the substrate through aligned transfer portions of the intermediate layer so as to be transferred to the substrate when the removable part of the lamina or substrate is separated from the form.

30. (canceled)

31. (canceled)

32. A form or label according to claim 1 wherein, tamper evident means is provided to indicate if the integrity of the form or label has been compromised.

33. (canceled)

34. (canceled)

35. (canceled)

36. A form or label according to claim 1 wherein the removable part of the form is releasably attached to the form by a peelable adhesive or perforations.

37. A form or label for securely carrying confidential information, the form or label comprising a printable face layer having a plurality of printable areas, a backing layer secured to the face layer and having a plurality of areas aligned with the printable areas of the face layer, the printable areas of the face layer being separable therefrom and the aligned areas of the backing layer including at least one transfer area separable therefrom, and a carrier layer releasably secured to the backing layer such that, when separating the carrier layer and the backing layer, the at least one transfer area remains secured to the carrier layer together with the aligned printable area of the face layer.

38. A method of producing a form for securely carrying confidential information including the steps of providing a lamina with a plurality of printable areas and selectively bonding at least one of the printable areas to a substrate whereby information printed on said at least one printable area of the lamina is transferred to the substrate leaving behind information printed on the remaining printable areas when the substrate or lamina is separated from the form.

39. A method according to claim 38 wherein the information transferred to the substrate is one of confidential information and dummy information with the information left behind on the lamina being the other of confidential information and dummy information.

40. (canceled)
